(19) United States
(12) Patent Application Publication
(10) Pub. No.: US 2026/0307305 A1
(43) Pub. Date: Oct. 8, 2026

(54) METAL-PLASTIC HYBRID MATERIALS WITH ALUMINUM AND/OR ALLOYS THEREOF AS METAL COMPONENT

(71) Applicant: CHEMETALL GMBH, Frankfurt (DE)

(72) Inventors: Nawel Souad KHELFALLAH, Frankfurt (DE); Thomas BURKHARDT, Frankfurt (DE); Heiko HELLMERS, Frankfurt (DE); Thomas WENDEL, Frankfurt (DE)

(21) Appl. No.: 19/108,213

(22) PCT Filed: Sep. 21, 2023
(86) PCT No.: PCT/EP2023/076066

§ 371 Date: Mar. 3, 2025

(30) Foreign Application Priority Data
Sep. 23, 2022 (EP) 22197352.2

(51) Int. Cl. B29C 45/14; B29L 9/00

(52) U.S. Cl. CPC B29C 45/14311; B29L 2009/005

(57) ABSTRACT

Described herein is a method for preparing a metal-plastic hybrid material, the material including at least one substrate having at least one metallic surface made at least partially of aluminum and/or of an alloy thereof and at least one thermoplastic material applied onto the metallic surface of the substrate, inter alia by making use of an acidic aqueous composition. Also described herein are a metal-plastic hybrid material obtainable by this method, a use of the acidic aqueous composition for adhering the substrate to the plastic, a metal-plastic hybrid material, and a use of the metal-plastic hybrid material as a component in the automotive, construction or electronic industry.

The present invention relates to a method for preparing a metal-plastic hybrid material, said material comprising at least one substrate having at least one metallic surface made at least partially of aluminum and/or of an alloy thereof and at least one thermoplastic material applied onto said metallic surface of the substrate, inter alia by making use of an acidic aqueous composition, a metal-plastic hybrid material obtainable by this method, a use of the acidic aqueous composition for adhering the substrate to the plastic, a metal-plastic hybrid material as such, and a use of the metal-plastic hybrid material as component in the automotive, construction or electronic industry.

### BACKGROUND OF THE INVENTION

Metal-plastic hybrid materials are one of the solutions proposed to reduce weight, either in parts such as structural parts used in the automotive industry or in other components, such as covers for battery materials, elements of powertrain, control panels etc. To obtain such parts and components, plastics and metals can be joined together in several ways to develop bonded materials with the ideal combination of characteristics of both materials, metal and plastic. Joining dissimilar materials such as metal and plastic is, however, very challenging not only because of the different chemical natures of both materials and, hence, of their surfaces, but also due to the shrinkage of the plastic materials such as thermoplastic materials, which is observed, e.g., upon molding, resulting from the dissimilarity of both materials.

Conventionally, an adhesive is used to bind a metal to a thermoplastic material. However, a method of producing such a product using an adhesive not only increases the number of production steps, but also the adhesive strength may decrease with time or integrating strength may not be exhibited at high temperatures. Therefore, applying such a method in technical fields such as the automotive industry, is not suitable—independently of the economic and ecological disadvantages associated therewith—, since here often a significant heat resistance is required because of electrodeposition and painting processes.

Aluminum is nowadays often used as metal component material of choice to build up metal-plastic hybrid materials, especially for electrical vehicles applications or electronics such as smartphone, mobile devices etc. Various methods have been reported describing the joining of aluminum to thermoplastic materials, especially in the electronic industry, where the aluminum surface is typically anodized, treated with plasma, or etched in a controlled manner to induce a surface roughness prior to an injection molding to be performed, e.g., by using nano molding technology (NMT).

Plastic-metal hybrid materials in general are often formed by such an injection molding of a thermoplastic material onto a surface of a metal part such as an aluminum part, the surface having nanometer-sized pores, micrometer-sized pores, or both. For example, WO 2020/003208 A1 discloses such plastic-metal hybrid materials, wherein the plastic contains a polyketone. The pores have usually been formed by the aforementioned controlled chemical etching or the anodizing process. The adhesion mechanism is based on mechanical interlocking, where the plastic material in molten state is directly injected in the pores of the metallic surface.

Both controlled chemical etching and anodizing processes (also called flash anodizing) require a special equipment and the disadvantage of having to employ an extra step of etching or anodizing when preparing the plastic-metal hybrid materials to generate the surface roughness. Such controlled chemical etching and anodizing processes are, e.g., disclosed in EP 2 894 240 A1 and EP 3 854 909 A1 as well as in JP 2021-186993 A: EP 2 894 240 A1 relates to a metal-resin composite structure, which is obtained by bonding a metal member and a resin member formed of a thermoplastic resin composition to each other. The surface of the metal member is necessarily roughened in order to achieve a sufficient adhesion between metal member and resin. EP 3 854 909 A1 relates to a metal/resin composite structure, which includes a metal member and a resin member, which is integrated to the metal member and is formed of a resin composition containing a thermoplastic resin. The metal member has a fine uneven shape at least on a surface of an integrating part with the resin member, i.e., has a surface roughness, which is the result of a surface roughening step performed. In addition, an inorganic particle layer is necessarily present between metal and resin member. JP 2021-186993 A discloses a metal/resin composite comprising a metal member and a cured resin bonded to the metal member. The metal member has a fine concavo-convex structure and, hence, a roughness, on the surface of the joint portion with the cured resin, which is prepared from a thermosetting polyurethane elastic material.

However, the lifetime of the resulting roughened, in particular etched or anodized, surface of the metal materials such as aluminum-based materials is very limited. Taking the example of anodizing, the application window or processing of the plastic material is of only a few hours, otherwise the pores naturally close and no adhesion can be obtained. Furthermore, aforementioned nano molding technology (NMT) can be only applied on very well-defined nanopores and very small parts, limiting the application to very small electronic devices. The engineering plastics suitable for this application are also limited: for example, polybutylene and polyethylene terephthalate (PBT and PET) become each discolored during further processing of parts due to their weak acid resistance. Nylon-based materials like polyamide (PA) and polyphthalamide (PPA) both have only a poor resistance to acids as well.

Thus, there is a need to provide metal-plastic hybrid materials and a method for preparing them, which materials contain aluminum and/or an alloy thereof as metal component, have excellent and permanent or at least long-lasting adhesion properties as far as the adhesion between metal and plastic is concerned, but which at the same time can be prepared without the necessity of using conventional adhesives and, further and in particular, without the necessity of having to perform a separate surface roughening step such as an anodizing step or a chemical etching of the surface, which materials further allow a broader spectrum of thermoplastic polymeric materials to be used including PBT and PET than in conventional processes for preparing metal-plastic hybrid materials containing aluminum and/or an alloy thereof, and which can be further prepared in a flexible, facilitated and ecologically and economically advantageous manner.

### Problem

It has been therefore an objective underlying the present invention to provide metal-plastic hybrid materials and a method for preparing them, which materials contain aluminum and/or an alloy thereof as metal component, have excellent and permanent or at least long-lasting adhesion properties as far as the adhesion between metal and plastic is concerned, but which at the same time can be prepared without the necessity of using conventional adhesives and, further, in particular without the necessity of having to perform a separate surface roughening step such as an anodizing step or a chemical etching of the surface, which materials further allow a broader spectrum of thermoplastic polymeric materials to be used including PBT and PET than in conventional processes for preparing metal-plastic hybrid materials containing aluminum and/or an alloy thereof, and which can be further prepared in a flexible, facilitated and ecologically and economically advantageous manner.

### Solution

This objective has been solved by the subject-matter of the claims of the present application as well as by the preferred embodiments thereof disclosed in this specification, i.e., by the subject matter described herein.

A first subject-matter of the present invention is a method for preparing a metal-plastic hybrid material, said material comprising a substrate S1 having at least one metallic surface and at least one thermoplastic material applied onto said metallic surface of the substrate S1, the method comprising at least steps 1) and 2) and optionally step 3a) or 3b), namely
1) applying an aqueous acidic composition at least in portion onto the at least one metallic surface of the substrate S1 to form a film at least in portion on said surface,
   wherein the metallic surface is made at least partially of aluminum and/or of at least one kind of aluminum alloy, and
   wherein the acidic aqueous composition comprises, besides water, at least one water-soluble polymer having least one kind of functional groups selected from acid groups, hydroxyl groups, amino groups, and mixtures thereof as at least one constituent a1), and at least one metal cation selected from the group of titanium, zirconium and hafnium ions, and mixtures thereof, as at least one constituent a2), and preferably free fluoride anions as at least one constituent a3), and
and optionally drying or curing the film to form a dried or cured layer,
2) applying at least one thermoplastic polymeric material TM1 at least in portion onto the film or onto the dried or cured layer obtained after step 1),
   wherein the at least one thermoplastic polymeric material TM1 is applied i) in form of a foil or is applied ii) by injection in a molten state onto the film or onto the dried or cured layer obtained after step 1) to form the metal-plastic hybrid material, and
3a) optionally injecting at least one thermoplastic polymeric material TM2, which is identical to or different from the thermoplastic material TM1 applied in step 2), and which is present in molten state, at least in portion onto the surface of the foil of the metal-plastic hybrid material obtained after step 2) and i), or
3b) optionally applying a further substrate S2 having at least one metallic surface, said surface being made at least partially of aluminum and/or at least one kind of aluminum alloy and having undergone the treatment of method step 1), onto the surface of the foil of the metal-plastic hybrid material obtained after step 2) and i), or vice versa.

A further subject-matter of the present invention is a metal-plastic hybrid material obtainable by this method.

A further subject-matter of the present invention is a use of the acidic aqueous composition, as defined in connection with aforementioned step 1) of the inventive method, for adhering a metallic surface made at least partially of aluminum and/or of at least one kind of aluminum alloy of a substrate to a thermoplastic material present on said surface in form of a foil or applied onto said surface by injection molding such as a thermoplastic material TM1.

A further subject-matter of the present invention is a metal-plastic hybrid material as such, i.e., a metal-plastic hybrid material comprising
a substrate S1 having at least one metallic surface, which is made at least partially of at least one kind of aluminum and/or of at least one kind of aluminum alloy,
a film or a dried or cured layer applied at least in portion over said metallic surface, the film or dried or cured layer being obtainable from applying the aqueous acidic composition, as defined in connection with aforementioned step 1) of the inventive method, at least in portion onto said metallic surface, and
at least one thermoplastic polymeric material TM1 in form of a foil or in a form obtainable from an injection molding, in each case applied at least in portion over the film or the dried or cured layer, preferably as defined in step 2) of the inventive method, and,
optionally, further, at least one thermoplastic polymeric material TM2, which is identical to or different from the thermoplastic polymeric material TM1, applied at least in portion in a form obtainable from an injection molding over the at least one thermoplastic polymeric material TM1, with the proviso that the thermoplastic polymeric material TM1 has been applied in form of a foil,
or
optionally, further, a substrate S2 having at least one metallic surface, said surface being made at least partially of aluminum and/or at least one kind of aluminum alloy, said substrate bearing a film or a dried or cured layer applied at least in portion over said metallic surface, the film or dried or cured layer being obtainable from applying the aqueous acidic composition as defined in connection with aforementioned step 1) of the inventive method, wherein said film or dried or cured layer present at least in portion on said metallic surface of the substrate S2 is in adjacent position to the at least one thermoplastic polymeric material TM1, with the proviso that the thermoplastic polymeric material TM1 has been applied in form of a foil.

Preferably, when the metal-plastic hybrid material comprises a further substrate S2, it can be regarded as a sandwich structure comprising two substrates S1 and S2, wherein each of these substrates is adhered to one surface of the thermoplastic material TM1, which is present in form of a foil, by means of an adherent film or dried or cured layer being obtainable from application the aqueous acidic composition as defined in connection with aforementioned step 1) of the inventive method. Preferably, substrates S1 and S2 each are sheets or coils made of aluminum and/or an alloy thereof.

A further subject-matter of the present invention is a use of said metal-plastic hybrid material or of the metal-plastic hybrid material obtainable by the inventive method as component in the automotive, construction or electronic industry.

It been found that the inventively used acidic aqueous composition is able to provide a conversion coating on the metallic surface of the substrate and at the same time provides a good adhesion between the metallic surface and the thermoplastic material TM1 applied on top of the metallic surface due to the adhesion promoting properties of the conversion coating film or layer formed. It has been found that without application of the acidic aqueous composition, no sufficient adhesion can be obtained. It has been further in particular surprisingly found, that the water-soluble polymer present in the acidic aqueous composition functions as adhesion promoter in this regard. Achieving an excellent adhesion is in particular relevant, since it has been found that the strength of the adhesion layer between the metallic surface and the thermoplastic material used has a significant impact on the lifetime of the metal-plastic hybrid material. Moreover, it has been found that metallic aluminum and/or aluminum alloy containing surfaces of all kinds of substrates of different shape can be used, in particular of sheets, coils and/or of other shaped substrates.

Moreover, it has been found that applying the inventively used acidic aqueous composition to the metallic surface according to step 1) represents a surface treatment of said metallic surface, which not only provides a micro-structuring of the surface, in particular when at least one metal cation selected from the group of titanium, zirconium and hafnium ions, and mixtures thereof, is present, preferably in combination with molybdenum cations, through a pickling passivation treatment, being important for the mechanical interlocking of thermoplastic polymeric material TM1, but also a true chemical bonding though the functional groups of the water-soluble polymers used. Since by applying the inventively used acidic aqueous composition to the metallic surface according to step 1) a surface roughness is already induced, there is no need to apply any conventional surface treatment to the metallic surface such as plasma treatment, chemical etching and/or anodization at all, let alone in a separate method step.

Further, it has been in particular surprisingly found that the adhesion problems and issues known in the prior art when combining the two dissimilar materials, namely a thermoplastic polymer TM1 on the one hand, and aluminum and/or an alloy thereof, on the other hand, can be overcome by the inventive method of preparing a metal-plastic hybrid material, in particular by using the acidic aqueous composition for chemical pretreatment of the metallic surface as illustrated in step 1) of the inventive method prior to performance of step 2). It has been found that the method of preparing the metal-plastic hybrid material in particular allows even using thermoplastic polymers such TM1 with comparably high melting temperatures such as polyamide, in particular polyamide 6, to be applied, directly by injection molding according to step 2) of the inventive method, and, further, of thermoplastic polyesters such as PET and PBT despite of their poor acid resistance. Injecting a thermoplastic material directly on metallic surface in accordance with step 2) offers many benefits, among them being simplicity, robustness, and a wide application window. Flexibility of the method can be, e.g., achieved as step 1) of the method can be used in coil line by a roll coater or can be sprayed at a job coater, which makes the method highly flexible.

It has also been found that not only an excellent adhesion is achieved, but also a very good protection against corrosion by applying the inventively used acidic aqueous composition.

It has been additionally surprisingly found that the inventive method allows a thermoplastic injection of thermoplastic polymer TM1 directly onto an aluminum-containing metallic surface in accordance with step 2) despite an only very short contact time between TM1 and the metallic surface, and despite a significant temperature difference between the molten thermoplastic polymer material TM2, which may exceed 200° C., and the substrate temperature of the surface, which usually is room temperature, i.e. in a range of from 18 to 25° C., but may also be heated, e.g., up to 60° C. if needed. It has been found that, in particular, the presence of the functional groups of the water-soluble polymer in the acidic aqueous composition used allow a very quick bonding prior to the cooling of the thermoplastic material once applied/injected.

Moreover, it has been found that using the acidic aqueous composition for chemical pretreatment of the metallic surface as illustrated in step 1) of the inventive method prior to performance of step 2) also provides a strong adhesion to a thermoplastic material TM1, when applied as foil compound to the treated metallic surface. It has also been found that the foil formed from applying TM1 can then further serve as such as an adhesion layer or an interface layer, onto which a further thermoplastic material TM2 being identical to or different from TM1 can be applied by injection in optional step 3a) of the method when performed, in particular when the foil formed in step 2) from TM1 is chemically compatible to material TM2 applied in optional step 3a). Likewise, it is also possible to apply the product of obtained after step 2), in particular when TM1 has been applied as a foil to the metallic surface, in an optional step 3b), to a metallic surface of a further substrate, said surface also being at least partially made of aluminum and/or an alloy thereof, when the metallic surface of the further substrate has also undergone a chemical pretreatment as defined in step 1) of the inventive method by making use of the inventively used acidic aqueous composition as well, to form a sandwich structure, wherein the foil made by using TM1 is flanked by the two metallic surfaces of the two substrates.

### DETAILED DESCRIPTION OF THE INVENTION

The term “comprising” in the sense of the present invention, in connection for example with the acidic aqueous composition, preferably has the meaning of “consisting of”. With regard, e.g., to the acidic aqueous composition, it is possible—in addition to all mandatory constituents present therein—for one or more of the further optional constituents identified hereinafter to be also included therein. All constituents may in each case be present in their preferred embodiments as identified below.

The proportions and amounts in wt.-% (% by weight) of any of the constituents given hereinafter, which are present in the acidic aqueous composition, add up to 100 wt.-%, based in each case on the total weight of the acidic aqueous composition.

### Inventive Method

A first subject-matter of the present invention is a method for preparing a metal-plastic hybrid material, said material comprising a substrate S1 having at least one metallic surface and at least one thermoplastic material applied onto said metallic surface of the substrate S1, the method comprising at least steps 1) and 2) and optionally step 3a) or 3b).

The method may comprise further steps besides steps 1) and 2) and optional steps 3a) or 3b). For example, a cleaning step of the metallic surface may be performed prior to step 1), e.g., by means of an acidic, alkaline or pH-neutral, preferably alkaline, cleaning composition, wherein in case of an acidic cleaning composition said composition is different from the acidic aqueous composition used in step 1).

More specifically, prior to step 1) one or more of the following optional steps can be performed in this order:
Step A-1): preferably alkaline or acidic cleaning and optionally subsequently rinsing the surface of the substrate,
Step B-1): subjecting the surface of the substrate to acidic pickling, i.e., etching, and subsequently rinsing the surface of the substrate,
Step C-1): contacting the surface of the substrate with an aqueous composition comprising at least one mineral acid, said aqueous composition being different from acidic aqueous composition used in step 1) or alternatively with an aqueous alkaline composition or pH-neutral aqueous composition and
Step D-1): rinsing the surface of the substrate obtained after the contact according to step C-1) and/or B-1).

Alternatively, steps A-1) and B-1) may be performed in one step, which is preferred. Preferably, both steps A-1) and B-1) are performed.

Optional step C-1) serves to remove aluminum oxide, undesired alloy components, the skin, brushing dust etc. from the surface of the substrate and to thereby activate the surface for the subsequent treatment in step 1). This step represents a chemical etching step. Preferably, the at least one mineral acid of the composition in step C-1) is sulfuric acid and/or nitric acid and/or phosphoric acid, more preferably sulfuric acid. The content of the at least one mineral acid is preferably in the range of 1.5 to 75 g/I, more preferably of 2 to 60 g/I and most preferably of 3 to 55 g/l. The composition used in step C-1) preferably additionally comprises one or more metal ions selected from the group of titanium, zirconium, hafnium ions and mixtures thereof, and optionally further comprises molybdenum ions. In the treatment of parts, the duration of treatment with the composition in step C-1) is preferably in the range of 30 seconds to 10 minutes, more preferably of 40 seconds to 6 minutes and most preferably of 45 seconds to 4 minutes. The treatment temperature is preferably in the range of 20 to 55° C., more preferably of 25 to 50° C. and most preferably of 30 to 45° C. In the treatment of coils, the duration of treatment is preferably in the range of 3 seconds to 1 minute, most preferably of 5 to 20 seconds. Preferably, however, optional step C-1) is not performed.

Preferably, the method does not comprise any step of a surface treatment of the metallic surface S1 selected from plasma treatment, chemical etching and/or anodization, in particular not prior to performance of step 1). None of optional steps B-1) and C-1 represents a chemical etching step, by which any surface roughness of the substrate can be generated as disclosed in the prior art. Optional step B-1) and/or C-1) rather merely are preparation steps for the subsequent deposition of a film obtained from applying the aqueous acidic composition in step 1).

Rinsing step D-1) and the optional rinsing being part of step A-1) are preferably performed by using deionized water or tap water. Preferably, step D-1) is performed by using deionized water.

Preferably, the method does not contain any step involving any treatment with chromium ions such as Cr(III) and/or Cr(VI) ions.

### Substrate

The metallic surface of substrate S1 is made at least partially of aluminum and/or of at least one kind of aluminum alloy. Preferably, the overall metallic surface is made at least partially of aluminum and/or of at least one kind of aluminum alloy. More preferably, the substrate S1 as such is a metallic substrate made at least partially of aluminum and/or of at least one kind of aluminum alloy. Preferably, the metallic surface does not comprise steel and/or a steel alloy in any amount exceeding the amount of aluminum and/or of the alloy thereof present therein. Examples of aluminum alloys are aluminum magnesium alloys, aluminum magnesium silicon alloys, aluminum copper alloys, aluminum zinc alloys, and aluminum zinc copper alloys.

In case of an aluminum alloy said alloy preferably contains more than 50 wt.-% of aluminum, based on the total weight of the alloy. The method is in particular suitable for all aluminum alloys containing more than 50 wt.-% aluminum, particularly for aluminum magnesium alloys, including, but not limited to AA5005, as well as for aluminum magnesium silicon alloys, including, but not limited to AA6014, AA6060 and AA6063, for cast alloys—e.g., AlSi7Mg, AlSi9Mg, AlSi10Mg, AlSi11Mg, AlSi12Mg—as well as for forge alloys—e.g., AlSiMg. Aluminum magnesium alloys, including AA5005, as well as aluminum magnesium silicon alloys, including AA6060 and AA6063, are commonly used in the field of, e.g., aluminum finishing and/or for the treatment of wheels and/or in other vehicle parts such as electrical vehicle parts, e.g., battery housings. The method is further suited for all alloys of the so-called AA1000, AA2000, AA3000, AA4000, AA5000, AA6000, AA7000 as well as AA8000 series. A preferred example of the AA2000 series is AA2024. A preferred example of the AA7000 series is AA7075. AA2024 and AA7075 are often used in the aerospace industry. Further examples are Galvalume® and Galfan®.

All kinds of substrates of different shapes and geometries can be used. Preferably, the substrate is selected from sheets and coils as well as parts, in particular parts suitable for use in the automotive industry, and mixtures thereof.

### Step 1) of the Method

In step 1) an aqueous acidic composition is applied at least in portion onto the at least one metallic surface of the substrate S1 to form a film at least in portion on said surface. An optional drying or curing of the film to form a dried or cured layer may be performed within step 1). Preferably, such a drying or curing is performed. Drying is preferably performed, e.g., at a temperature in the range of 15° C. to 100° C., more preferably at a temperature in the range of 18° C. to 95° C., in particular at a temperature in the range of 20° C. to 90° C.

Step 1) preferably is a contacting step, where the metallic surface is contacted with the aqueous acidic composition. “Contacting” includes a spraying, dip coating, cascade or roll coating procedure. “Contacting” may also be a flooding of the surface or even a manual wiping or brushing.

The treatment time, i.e., the period of time the surface is contacted with the acidic aqueous composition used in step 1) is preferably of from 15 seconds to 20 minutes, more preferably of from 30 seconds to 10 minutes, and most preferably of from 45 seconds to 5 minutes, as for example of from 1 to 3 minutes, preferably in each case when parts, in particular parts suitable for use in the automotive industry, are used as substrate. In case the substrate is a coil, the treatment time is preferably less than 1 minute, more preferably less than 30 or 15 seconds, even more preferably less than 10 seconds, still more preferably in a range of from 1 to 5 seconds.

The temperature of the acidic aqueous composition used in step 1) is preferably of from 5 to 50° C., more preferably of from 15 to 45° C. and most preferably of from 25 to 40° C.

By performing step 1) preferably a conversion coating film is formed on the metallic surface. Preferably, a coating layer is preferably formed after drying or curing, preferably drying, that has a coating weight determined by XRF (X-ray fluorescence spectroscopy) of: 0.1 to 50 mg/m², more preferably 0.2 to 30 mg/m², even more preferably 0.5 to 20 mg/m², still more preferably 1.0 to 15 mg/m², yet more preferably 1.5 to 10 mg/m², in particular 2.0 to 8 mg/m², of zirconium and/or titanium and/or hafnium, preferably of zirconium and/or titanium, more preferably of zirconium, in each case calculated as metal, due to the presence of constituent a2) in the acidic aqueous composition. Preferably, in case optional constituents a4) as defined hereinafter is also present, the coating layer has a coating weight determined by XRF (X-ray fluorescence spectroscopy) of: 0.1 to 40 mg/m², more preferably 0.2 to 30 mg/m², even more preferably 0.5 to 20 mg/m², still more preferably 1.0 to 15 mg/m², yet more preferably 1.5 to 10 mg/m², in particular 2.0 to 8 mg/m², of molybdenum, calculated as metal.

### Acidic Aqueous Composition

The acidic aqueous composition comprises, besides water, at least one water-soluble polymer having least one kind of functional groups selected from acid groups, hydroxyl groups, amino groups, and mixtures thereof as at least one constituent a1), and at least one metal cation selected from the group of titanium, zirconium and hafnium ions, and mixtures thereof, as at least one constituent a2). All constituents present in the composition are different from each other.

Preferably, the acidic aqueous composition used in step 1) has a pH value in a range of from 0.1 to <7.0, more preferably of from 0.5 to 6.5, still more preferably of from 1.0 to 6.0, even more preferably of from 1.5 to 5.5, still more preferably of from 2.0 to 5.0, yet more preferably of from 2.5 to 4.5, still more preferably of from 3.0 to 4.0, most preferably of from >3.0 to <3.7. Preferably, the pH value is measured at room temperature (23° C.). The pH can be preferably adjusted by using nitric acid, aqueous ammonia and/or sodium carbonate if necessary.

The term “aqueous” with respect to the acidic aqueous composition used in step 1) in the sense of the present invention preferably means that the composition is a composition containing at least 50 wt.-%, preferably at least 60 wt.-%, more preferably at least 70 wt.-%, in particular at least 80 wt.-%, most preferably at least 90 wt.-% of water, based on its total content of organic and inorganic solvents including water. Thus, the composition may contain at least one organic solvent besides water—however, in an amount lower than the amount of water present.

Preferably, the acidic aqueous composition used in step 1) contains at least 50 wt.-%, preferably at least 60 wt.-%, more preferably at least 70 wt.-%, in particular at least 80 wt.-%, most preferably at least 90 wt.-% of water, in each case based on its total weight.

The acidic aqueous composition can be used as a dip coat bath. However, it can also be applied by virtually any conventional coating procedure like, e.g., spray coating, roll coating, brushing, wiping etc. as outlined above in connection with step 1). Spraying, dipping, cascade or roll coating is preferred.

The acidic aqueous composition used in step 1) preferably is a solution.

Preferably, the acidic aqueous composition used in step 1) has a temperature in a range of from 18 to 35° C., more preferably of from 20 to 35° C., in particular of from 20 to 30° C.

Water-Soluble Polymer (Constituent a1))

The acidic aqueous composition comprises at least one water-soluble polymer having least one kind of functional groups selected from acid groups, hydroxyl groups, amino groups, and mixtures thereof as at least one constituent a1).

Solubility is determined at a temperature of 20° C. and atmospheric pressure (1.013 bar).

Preferably, the at least one water-soluble polymer used as constituent a1) is present in the acidic aqueous composition in an amount in a range of from 0.05 to 2.0 g/L or 0.05 to 5.0 g/L, more preferably of from 0.10 to 1.8 g/L, even more preferably of from 0.12 to 1.6 g/L, still more preferably of from 0.14 to 1.5 g/L, yet more preferably of from 0.16 to 1.4 g/L, still more preferably of from 0.18 to 1.2 g/L, most preferably of from 0.20 to 1.0 g/L. Alternatively, the at least one water-soluble polymer used as constituent a1) is present in the acidic aqueous composition in an amount in a range of from 0.1 to 15.0 g/L, more preferably of from 0.3 to 12.0 g/L, even more preferably of from 0.5 to 11.0 g/L, still more preferably of from 0.7 to 10.0 g/L.

Preferably, the at least one water-soluble polymer used as constituent a1) has at least one kind of functional groups selected from carboxylic acid groups, phosphonic acid groups, sulfonic acid groups, hydroxyl groups, amino groups, and mixtures thereof, more preferably selected from carboxylic acid groups, hydroxyl groups, amino groups, and mixtures thereof, even more preferably selected from carboxylic acid groups.

Preferably, the at least one water-soluble polymer used as constituent a1) is a homopolymer or copolymer obtainable from polymerization of at least one kind of ethylenically unsaturated monomers, wherein at least part of said monomers bear at least one kind of functional groups selected from acid groups, hydroxyl groups, amino groups, and mixtures thereof, more preferably is a homopolymer or copolymer obtainable from polymerization of at least one kind of vinyl monomers and/or (meth)acrylic monomers, wherein at least part of said monomers bear at least one kind of functional groups selected from acid groups, hydroxyl groups, amino groups, and mixtures thereof. In particular in case of homopolymers and copolymers of vinyl phenol, it is possible to modify these polymers via a condensation reaction, in particular a Mannich reaction, with amino-group(s) bearing compounds such as ethanolamine and/or N-methyl glucamine.

Examples of monomers comprising an acid group are acrylic acid and methacrylic acid as well as maleic acid. Examples of monomers comprising a hydroxyl group are 2-hydroxyethyl acrylate, 2-hydroxyethyl methacrylate, 3-hydroxypropyl acrylate, 3-hydroxypropyl methacrylate, 4-hydroxybutyl acrylate, 4-hydroxybutyl methacrylate, 3-phenoxy-2-hydroxypropyl (meth)acrylate, glycerol mono (meth)acrylate, N-(2-hydroxypropyl) (meth)acrylamide, allyl alcohol, hydroxystyrene, hydroxyalkyl vinyl ethers such as hydroxybutyl vinyl ether and vinylbenzyl alcohol, vinyl phenol and vinyl alcohol. Examples of further non-functional monomers, which can be additionally used and which in particular do not bear acid groups, hydroxyl groups, and mixtures thereof, are ethylene, propylene, butylene as well as (meth)acrylic esters of aliphatic C₁-C₃₀-monoalcohols, e.g., methyl (meth)acrylate, ethyl (meth)acrylate, n-propyl (meth)acrylate), i-propyl (meth)acrylate, n-butyl (meth)acrylate, i-butyl (meth)acrylate, t-butyl (meth)acrylate, lauryl (meth)acrylate, 2-ethylhexyl (meth)acrylate, 3-propylheptyl (meth)acrylate, stearyl (meth)acrylate, behenyl (meth)acrylate, benzyl (meth)acrylate, cyclohexyl (meth)acrylate and isobornyl (meth)acrylate. However, non-functional vinyl monomers are preferred, in particular over non-functional (meth)acrylic esters of aliphatic C₁-C₃₀-monoalcohols.

If polymer a1) is a homopolymer, it preferably is a poly(meth)acrylic acid. If polymer a1) is a copolymer and bears at least acid groups as functional groups, it preferably is a (meth)acrylic copolymer, which preferably comprises a polymeric backbone and at least one kind of side chains attached to said polymeric backbone, which bear acid groups such as carboxylic acid groups.

The term “(meth)acryl” means “acryl” and/or “methacryl”. Similarly, “(meth)acrylate” means acrylate and/or methacrylate, and “(meth)acrylic” means acrylic and methacrylic. A “(meth)acrylic polymer” is formed it least partially from “acrylic monomers” and/or “methacrylic monomers”, but additionally may contain non-acryl and non-methacryl monomeric units if other ethylenically unsaturated monomers such as vinyl monomers are additionally used in case polymer a1) is a copolymer. Preferably, the backbone of such a (meth)acrylic copolymer is formed from more than 50 mol-%, even more preferably of from more than 75 mol-%, of (meth)acrylic monomers.

Preferably, the at least one water-soluble polymer used as constituent a1) is selected from
(meth)acrylic acid homopolymers, in particular acrylic acid homopolymers,
copolymers of (meth)acrylic acid and at least one kind of ethylenically unsaturated monomers different from (meth)acrylic acid, in particular copolymers of (meth)acrylic acid and maleic acid,
copolymers of maleic acid and at least one kind of ethylenically unsaturated monomers different from maleic acid, in particular copolymers of maleic acid and ethylene and/or propylene and/or at least one kind of alkyl vinyl ethers such as methyl vinyl ether,
copolymers of vinyl phosphonic acid and at least one kind of ethylenically unsaturated monomers different from vinyl phosphonic acid, in particular copolymers of (meth)acrylic acid and vinyl phosphonic acid as well as copolymers of (meth)acrylic acid and vinyl phosphonic acid and maleic acid,
vinyl alcohol homopolymers,
copolymers of vinyl alcohol and at least one kind of ethylenically unsaturated monomers different from vinyl alcohol such as vinyl acetate,
vinyl phenol homopolymers,
copolymers of vinyl phenol and at least one kind of ethylenically unsaturated monomers different from vinyl phenol,
copolymers of vinyl mercaptoethanol and at least one kind of ethylenically unsaturated monomers different from vinyl mercaptoethanol, and
homopolymers and copolymers of vinyl phenol, which have been modified with at least one amine, preferably at least one primary amine such as N-ethanolamine and/or N-methyl glucamine, and mixtures thereof. The modification is preferably performed via a Mannich base reaction based on the condensation of formaldehyde with a primary or secondary amine.

More preferably, the at least one water-soluble polymer used as constituent a1) is selected from (meth)acrylic acid homopolymers, in particular acrylic acid homopolymers, copolymers of (meth)acrylic acid and at least one kind of ethylenically unsaturated monomers different from (meth)acrylic acid, in particular copolymers of (meth)acrylic acid and maleic acid, copolymers of maleic acid and at least one kind of ethylenically unsaturated monomers different from maleic acid, in particular copolymers of maleic acid and ethylene and/or propylene and/or at least one kind of alkyl vinyl ethers such as methyl vinyl ether, vinyl alcohol homopolymers, copolymers of vinyl alcohol and at least one kind of ethylenically unsaturated monomers different from vinyl alcohol, homopolymers and copolymers of vinyl phenol, which have been modified with at least one amine, preferably at least one primary amine or secondary amine such as N-ethanolamine and/or N-methyl glucamine, and mixtures thereof.

Particularly preferable polymers are N-Methyl glucamine-modified poly(vinyl phenol), N-Ethanolamine-modified poly(vinyl phenol), poly(maleic acid-co-vinyl methyl ether), poly(maleic acid-co-acrylic acid), polyacrylic acid, poly(vinyl-phosphonic acid-co-acrylic acid), poly(acrylic acid-co-maleic acid-co-vinyl phosphonic acid), poly(acrylic acid-co-vinyl mercaptoethanol), poly(acrylic acid-co-maleic acid-co-vinyl mercaptoethanol) and mixtures thereof.

Preferably, the at least one water-soluble polymer has a weight average molecular weight (M_{w}) in a range of from 1 000 to 350 000 g/mol, preferably of from 2 000 to 325 000 g/mol, more preferably of from 3 000 to 300 000 g/mol, still more preferably of from 4 000 to 375 000 g/mol. The weight average molecular weight is determined by the method described hereinafter in the ‘methods’ section.

If a polymer a1) is used, which is a poly(meth)acrylic acid, in particular a polyacrylic acid, it preferably has a weight average molecular weight (M_{w}) in a range of from 10 000 to 350 000 g/mol, preferably of from 50 000 to 325 000 g/mol, more preferably of from 100 000 to 300 000 g/mol, still more preferably of from 150 000 or 200 000 to 375 000 g/mol. If a polymer a1) is used, which is a copolymer at least partially prepared from maleic acid, it preferably has a weight average molecular weight (M_{w}) in a range of from 10 000 to 200 000 g/mol, preferably of from 15 000 to 150 000 g/mol, more preferably of from 20 000 to 100 000 g/mol, still more preferably of from 30 000 to 80 000 g/mol. If a polymer a1) is used, which is a homopolymer or copolymer at least partially prepared from vinyl alcohol and/or vinyl phenol, it preferably has a weight average molecular weight (M_{w}) in a range of from 500 to 100 000 g/mol, preferably of from 750 to 50 000 g/mol, more preferably of from 1 000 to 25 000 g/mol, still more preferably of from 1 000 to 10 000 g/mol.

### Constituent a2)

The acidic aqueous composition used in step 1) further comprises at least one metal cation selected from the group of titanium, zirconium and hafnium ions, and mixtures thereof, as at least one constituent a2).

Preferably, the aqueous acidic composition used in step 1) comprises the at least one constituent a2) in an amount in a range of from 0.1 to 10 g/L, in each case calculated as metal, wherein constituent a2) is preferably selected from titanium and zirconium ions and mixtures thereof, most preferably is selected from zirconium ions. The content of constituent a2) can be monitored and determined by the means of ICP-OES (optical emission spectroscopy with inductively coupled plasma). Said method is described hereinafter in detail. Preferably, when the aqueous acidic composition used in step 1) is applied by spraying, it comprises the at least one constituent a2) in an amount in a range of from 0.1 to 1.0 g/L, more preferably of from 0.2 to 0.6 g/L, even more preferably of from 0.2 to 0.4 g/L, in each case calculated as metal. Preferably, when the aqueous acidic composition used in step 1) is applied by roller coating, it comprises the at least one constituent a2) in an amount in a range of from 0.2 to 8.0 g/L, more preferably of from 0.5 to 7.5 g/L, even more preferably of from 0.7 to 5.0 g/L, yet more preferably of from 1.0 to 3.0 or 2.0 g/L, in each case calculated as metal.

Preferably, a precursor metal compound is used to generate the metal cations present as constituent a2) in the composition. Preferably, the precursor metal compound is water-soluble. Solubility is determined at a temperature of 20° C. and atmospheric pressure (1.013 bar).

Particularly preferred zirconium, titanium and/or hafnium compounds are the complex fluorides of these metals. The term “complex fluoride” includes the single and multiple protonated forms as well as the deprotonated forms. It is also possible to use mixtures of such complex fluorides. Complex fluorides in the sense of the present invention are complexes of zirconium, titanium and/or hafnium formed with fluoride ions in the composition, e.g., by coordination of fluoride anions to zirconium, titanium and/or hafnium cations in the presence of water. Moreover, also the use of the carbonates and/or complex carbonates and/or lactates and/or in particular nitrates of zirconium, titanium and/or hafnium is possible. However, preferably, the cations are incorporated into the composition in form of their complex fluorides.

Further Optional Constituents (Constituents a3), a4) and/or a5))

The aqueous acidic composition may comprise further constituents as lined out in the hereinafter. The term “further comprises”, as used herein throughout the description in view of the ingredients of the aqueous compositions, means “in addition to the mandatory constituents. Therefore, such “further” constituents include ions different from the above-mentioned metal ions.

Optionally and preferably, the acidic aqueous composition used in step 1) further comprises at least one constituent a3), namely free fluoride anions as at least one constituent a3). If free fluoride anions are present, they preferably are present in an amount in a range of from 1 to 50 mg/L, more preferably of from 2 to 40 mg/L, even more preferably of from 3 to 30 mg/L, yet more preferably of from 5 to 25 mg/L, calculated in each case as fluorine.

The acidic aqueous composition used in step 1) optionally and preferably contains free fluoride anions as constituent a3). These may result from the presence of constituent a2), i.e., in particular when complex fluorides of Ti, Zr and/or Hf are present in the composition, but may also or alternatively result from the presence of other optional constituents as described hereinafter such as by incorporation of at least one water-soluble fluorine compound. Examples of such water-soluble fluorine compounds are fluorides (other than complex fluorides of Ti, Zr and/or Hf) as well as hydrofluoric acid. The free fluoride content is determined by means of a fluoride ion sensitive electrode according to the method disclosed in the ‘methods’ section).

Optionally and preferably, the acidic aqueous composition used in step 1) further comprises
molybdenum cations as at least one constituent a4), preferably in an amount in a range of from 0.01 to 8.0 g/L, calculated as metal.

Preferably, particularly when the aqueous acidic composition used in step 1) is applied by spraying, it comprises the at least one constituent a4) in an amount in a range of from 0.01 to 0.2 g/L, more preferably of from 0.01 to 0.1 g/L, even more preferably of from 0.01 to 0.05 or to 0.03 g/L, in each case calculated as metal. Preferably, particularly when the aqueous acidic composition used in step 1) is applied by roller coating, it comprises the at least one constituent a4) in an amount in a range of from 0.2 to 8.0 g/L, more preferably of from 0.4 to 7.5 g/L, even more preferably of from 0.5 to 6.0 g/L, in each case calculated as metal.

Preferably, the amount of constituent a4) is lower than the amount of constituent a2).

For preparing the aqueous acidic composition preferably a water-soluble (at a temperature of 20° C. and atmospheric pressure (1.013 bar)) molybdenum salt is used in case the composition contains a4). Preferably, the molybdenum ions are incorporated in form of at least one molybdate, preferably at least one ammonium molybdate.

Optionally, the acidic aqueous composition used in step 1) further comprises at least one organosilane as optional constituent a5), preferably in an amount in a range of from 10 to 500 ppm, more preferably of from 20 to 100 ppm.

Examples are, e.g., (3-aminopropyl)trimethoxysilane, (3-aminopropyl)triethoxysilane, N-2-aminoethyl-3-aminopropyltrimethoxysilane, (3-mercaptopropyl)trimethoxysilane, (3-mercaptopropyl)triethoxysilane, (3-glycidyloxypropyl)trimethoxysilane and/or (3-glycidyloxypropyl)triethoxysilane, and/or vinyltrimethoxysilane.

### Additional Optional Constituents

Optionally, the aqueous acidic composition further comprises at least one kind of metal cations selected from the group of cations of metals of the 1^{st} to 3^{rd} subgroup (copper, zinc and scandium groups) and 5^{th} to 8^{th} subgroup (vanadium, chromium, manganese, iron, cobalt and nickel groups) of the periodic table of the elements including the lanthanides as well as the 2^{nd} main group of the periodic table of the elements (alkaline earth metal group), lithium, bismuth and tin. Preferably, however no metal cation of the chromium, cobalt and nickel groups is used. The before-mentioned metal cations are generally introduced in form of their water-soluble compounds, preferably as their water-soluble salts. Preferred cation(s) is/are selected from the group consisting of cations of cerium and the other lanthanides, iron, calcium, copper, magnesium, manganese, niobium, tantalum, yttrium, vanadium, lithium, bismuth, zinc and tin.

Optionally, the aqueous acidic composition further comprises at least one pH-Value adjusting substance, preferably selected from the group consisting of nitric acid, sulfuric acid, methanesulfonic acid, acetic acid, aqueous ammonia, sodium hydroxide and sodium carbonate, wherein nitric acid, aqueous ammonia and sodium carbonate are preferred. Depending on the pH value of the acidic aqueous composition the above compounds can be in their fully or partially deprotonated form or in protonated forms.

Optionally, the aqueous acidic composition further comprises at least one complexing agent. An example is 1-Hydroxyethane-1,1-diphosphonic acid (HEDP).

Optionally, the aqueous acidic composition further comprises at least one corrosion inhibitor. Examples are L-cysteine and other amino acids, benzotriazole and mixtures thereof. Preferably, the at least one corrosion inhibitor does not comprise any kind of metal ions.

Optionally, the aqueous composition further comprises at least one organic acid, preferably at least one organic acid having at least two carboxylic acid groups and/or at least one organic acid having at least one carboxylic acid groups and at least one further functional group having at least one donor atom such an OH-group, e.g., lactic acid, in particular when the aqueous composition is alkaline. The presence of such a compound may be helpful for stabilization of the at least one metal ion in the composition such as Zr cations.

Optionally, the aqueous acidic composition further comprises phosphate anions, which may be preferably added in the form of phosphoric acid. Preferably, phosphate anions are present in an amount in a range of from 0.5 to 90 g/L, calculated as P₂O₅.

The aqueous composition may further comprise at least one of the following constituents: one or more waxes, one or more wetting agents and one or more defoamers.

### Optional Step 1a)

After step 1) the surface of the substrate obtained after contact according to step 1) can be optionally rinsed, preferably with deionized water or tap water (optional step 1a)). If this step is performed, it is preferably done prior to any drying or curing performed within step 1).

### Step 2) of the Method

In step 2) at least one thermoplastic polymeric material TM1 is applied at least in portion onto the film or onto the dried or cured layer obtained after step 1), wherein the at least one thermoplastic polymeric material TM1 is applied i) in form of a foil (option i)) or is applied ii) by injection in a molten state (option (ii)) onto the film or onto the dried or cured layer obtained after step 1) to form the metal-plastic hybrid material. Preferably, step 2), option i) is not performed by injection molding.

The formed foil obtained from using thermoplastic polymeric material TM1 in step 2), first option i), preferably serves as compatibilizer material for an optionally subsequently injected thermoplastic polymeric material TM2 in optional step 3a).

Step 2), second option ii), as well as optional step 3a), each represent injection molding steps, where the thermoplastic polymeric material TM1 (or TM2 in case of step 3a)) is injected directly onto the metallic surface of the substrate, to which prior to that the acidic aqueous composition has been applied in step 1).

Step 2) can be performed in a continuous or discontinuous manner.

The substrate obtained after step 1) or after optional step 1a) is preferably heated before step 2) is performed, preferably heated to a temperature above the melting temperature of the thermoplastic material TM1 used.

Preferably, thermoplastic polymeric material TM1 used in step 2) and/or the thermoplastic polymeric material TM2 used in optional step 3a) is applied in a manner such that a vacuum is applied to contact the respective thermoplastic polymeric material with at least a portion, but preferably with the entire surface of the substrate, which surface had been contacted with the acidic aqueous composition within step 1), and to remove air enclosed between the surface of the substrate and the respective thermoplastic polymeric material. Preferably, the temperature of the substrate and the respective thermoplastic polymeric material applied thereto is held above a temperature, at which the connection of the applied thermoplastic polymeric material and the metal substrate is promoted. After the aforementioned heating, the substrate is preferably placed into a device in which the respective thermoplastic polymeric material can be placed on the surface of the substrate, preferably a thermoforming device: e.g., in which the thermoplastic polymeric material TM1 can be applied as a foil. As an alternative, it is also possible to firstly place the substrate into the device, in which the respective thermoplastic polymeric material is going to be applied and then heat the substrate before placing the thermoplastic polymeric material on it. Preferably, after the heated substrate is placed in the device or after the substrate is placed in the device and then heated, the respective thermoplastic polymeric material is placed on the substrate and optionally heated, such as in case of step 2), option ii) where the material in injected in a molten state. If the thermoplastic polymeric material is heated, the heating can be, e.g., carried out by infrared radiation.

The temperature to which the thermoplastic polymeric material is heated preferably is selected such that the thermoplastic material is rubbery elastic. For this purpose, the thermoplastic material preferably is heated to a temperature above the glass transition temperature of the thermoplastic material, if the thermoplastic material is an amorphous thermoplast, or above the crystallite melting temperature, if the thermoplastic material is a semi-crystalline thermoplast, but preferably below the melting temperature to avoid any damage. After having placed the respective thermoplastic polymeric material on the surface of the substrate and optionally after having heated the material, a vacuum is preferably applied as described hereinbefore. By applying the vacuum, the thermoplastic polymeric material is preferably attached to the surface of the substrate and a strong connection can be achieved. Removing the air which may be enclosed between the surface of the substrate and the thermoplastic polymeric material preferably results in a smooth surface without blisters. For applying the vacuum, the substrate may comprise openings through which air can be withdrawn. If the substrate should not have any openings, it is also possible to withdraw the air between the substrate and the thermoplastic polymeric material at the edges of the thermoplastic polymeric material. If the air is withdrawn at the edges, it is preferred to withdraw the air at least at two opposite sides and preferably over the whole circumference of the respective thermoplastic polymeric material. For applying the vacuum, any suitable vacuum pump can be used. If the air is withdrawn at the edges of the thermoplastic polymeric material, the respective thermoplastic polymeric material is preferably fixed such in a device for applying the vacuum, that a gap is formed between the substrate and the edge of the thermoplastic polymeric material and the vacuum is applied through that gap. By applying the vacuum, the thermoplastic polymeric material preferably contacts the substrate uniformly over its entire surface and, thus, a uniform layer is formed on the surface of the substrate.

After having contacting the thermoplastic polymeric material with the preferably entire surface of the substrate, the temperature of the substrate and the respective thermoplastic polymeric material is preferably held at the temperature at which the connection of the thermoplastic material and the substrate is promoted, preferably at a temperature above the melting temperature of the thermoplastic material. By holding the temperature, the thermoplastic material preferably reacts chemically at least with the functional groups water-soluble polymer originally present in the acidic aqueous composition, by which a stable connection of the surface of the substrate and the respective thermoplastic polymeric material is achieved and a composite component comprising a “metal layer” (metallic surface of the substrate) and “polymer layer” (applied thermoplastic material) is formed.

Preferably, at least prior to performing step 2), option ii) the substrate obtained after step 1), optionally 1a) is placed into a mold before step 3) is carried out.

### Optional Step 3a)

In optional step 3a) at least one thermoplastic polymeric material TM2, which is identical to or different from the thermoplastic material TM1 applied in step 2), and which is present in molten state, is injected at least in portion onto the surface of the foil of the metal-plastic hybrid material obtained after step 2) and i).

If optional step 3a) is performed, the thermoplastic polymeric material TM2 is preferably different from thermoplastic polymeric material TM1.

### Optional Step 3b)

In an optional step 3b) a further substrate S2 having at least one metallic surface, said surface being made at least partially of aluminum and/or at least one kind of aluminum alloy and having undergone the treatment of method step 1), i.e., by making use of the acidic aqueous composition, is applied onto the surface of the foil of the metal-plastic hybrid material obtained after step 2) and i), or vice versa.

### Thermoplastic Polymeric Materials TM1 and TM2

Thermoplastic polymeric material TM1 may be identical to or different from thermoplastic material TM2, preferably is different therefrom.

Preferably, the thermoplastic polymeric material TM1 is able to chemically bind to the functional groups of the water-soluble polymer originally present in the acidic aqueous composition used in step 1).

Preferably, thermoplastic polymeric material TM1 is selected from polyamides, polyesters such as PET and/or PBT, polyurethanes, polycarbonates, polyolefins such as polypropylenes and polyethylenes, as well as mixtures thereof. It is possible to use recycled thermoplastic polymeric materials such as recycled polyamides. Preferably, the polyamides are selected from PA6, PA66, PA66/6, PA6.10, PA6.12, PA12, PA9T, PA6I/6T, PA6T/6I, PA6/6.36 and combinations thereof. Most preferred are polyesters such as PET and/or PBT, and polyamides. Preferably, at least one polyester is applied via step 2) (i) or (ii) as the at least one thermoplastic polymeric material TM1.

It is possible to use the thermoplastic polymeric material TM1 such as polyamides in a form, where it has been compounded with at least one additive such as at least one rubber such as EPDM (ethylene propylene diene monomer) rubber, in particular to improve the properties of the thermoplastic polymeric material such as to reduce its water uptake. Alternatively or additionally, the thermoplastic polymeric material TM1 and/or TM2, preferably TM2 may optionally comprise (i) at least one kind of fiber such as glass fibers, carbon fibers, aramid fibers and combinations thereof, and/or may optionally comprise (ii) a polyether block polyamide such as copolymerisates of polyether diamines and aliphatic C₄ to C₄₀ dicarboxylic acids and/or C₆ to C₁₂ lactams like caprolactam or lauryllactam, copolymerisates of aliphatic C₄ to C₁₀ diamines and aliphatic C₄ to C₄₀ dicarboxylic acids, polycondensates of C₆ to C₁₂ lactams, copolymerisates of lactams and/or aliphatic dicarboxylic acids and aliphatic diamines and combinations thereof, and/or may optionally comprise (iii) at least one impact modifier like maleic anhydride grafted copolymers of ethylene and at least one of alpha-olefins, (meth)acrylic acid esters, and (meth)acrylic acid, copolymers of maleic anhydride and at least one of ethylene and (meth)acrylic acid esters, styrene maleic anhydride or maleic anhydride grafted polypropylene.

Preferably, thermoplastic polymeric material TM2 is selected from polyamides, polyesters such as PET and/or PBT, polyolefins such as polypropylenes and polyethylenes, as well as mixtures thereof. Preferably, the polyamides are selected from PA6, PA66, PA66/6, PA6.10, PA6.12, PA12, PA9T, PA6I/6T, PA6T/6I, PA6/6.36 and combinations thereof. It is possible to use recycled thermoplastic polymeric materials such as recycled polyamides.

Preferably, thermoplastic polymeric material TM1 has a melting temperature in a range of from 80° C. to 280° C. For example, polyolefins may have a melting temperature of 80° C., whereas polyamides have a significantly higher melting temperature of, e.g., 280° C.

Preferably, thermoplastic polymeric material TM2 has a melting temperature in a range as defined for thermoplastic polymeric material TM1.

### Metal-Plastic Hybrid Material Obtainable by the Inventive Method

A further subject-matter of the present invention is a metal-plastic hybrid material obtainable by the inventive method.

All preferred embodiments described above herein in connection with the inventive method and preferred embodiments thereof are also preferred embodiments of the inventive metal-plastic hybrid material obtainable by said method.

Preferably, the dry layer thickness of a layer obtained from drying or curing the film obtainable from applying the aqueous acidic composition, as defined in connection with aforementioned step 1) of the inventive method, at least in portion onto said metallic surface, is in a range of from 100 to 1000 nm, more preferably of from 150 to 750 nm, in particular of from 250 to 550 nm.

### Use of the Acidic Aqueous Composition

A further subject-matter of the present invention is a use of the acidic aqueous composition, as defined in connection with aforementioned step 1) of the inventive method, for adhering a metallic surface made at least partially of aluminum and/or of at least one kind of aluminum alloy of a substrate to a thermoplastic polymeric material present on said surface in form of a foil or applied onto said surface by injection molding such as a thermoplastic material TM1, preferably by making use of the inventive method.

All preferred embodiments described above herein in connection with the inventive method, the inventive metal-plastic hybrid material obtainable by said method, and preferred embodiments thereof are also preferred embodiments of the inventive use.

### Metal-Plastic Hybrid Material

A further subject-matter of the present invention is a metal-plastic hybrid material as such, i.e., a metal-plastic hybrid material comprising
a substrate S1 having at least one metallic surface, which is made at least partially of at least one kind of aluminum and/or of at least one kind of aluminum alloy,
a film or a dried or cured layer applied at least in portion over said metallic surface, the film or dried or cured layer being obtainable from applying the aqueous acidic composition, as defined in connection with aforementioned step 1) of the inventive method, at least in portion onto said metallic surface, and
at least one thermoplastic polymeric material TM1 in form of a foil or in a form obtainable from an injection molding, in each case applied at least in portion over the film or the dried or cured layer, preferably as defined in step 2) of the inventive method, and,
optionally, further, at least one thermoplastic polymeric material TM2, which is identical to or different from the thermoplastic polymeric material TM1, applied at least in portion in a form obtainable from an injection molding over the at least one thermoplastic polymeric material TM1, with the proviso that the thermoplastic polymeric material TM1 has been applied in form of a foil,
or
optionally, further, a substrate S2 having at least one metallic surface, said surface being made at least partially of aluminum and/or at least one kind of aluminum alloy, said substrate bearing a film or a dried or cured layer applied at least in portion over said metallic surface, the film or dried or cured layer being obtainable from applying the aqueous acidic composition as defined in connection with aforementioned step 1) of the inventive method, wherein said film or dried or cured layer present at least in portion on said metallic surface of the substrate S2 is in adjacent position to the at least one thermoplastic polymeric material TM1, with the proviso that the thermoplastic polymeric material TM1 has been applied in form of a foil.

Preferably, the metal-plastic hybrid material is obtainable by the inventive method.

Preferably, the thermoplastic polymeric material TM1 being present in form of a laminate or in a form obtainable from an injection molding, has a total thickness in a range of from 200 to 800 μm.

All preferred embodiments described above herein in connection with the inventive method, the inventive metal-plastic hybrid material obtainable by said method, the inventive use, and preferred embodiments thereof, are also preferred embodiments of the inventive metal-plastic hybrid material as such.

Preferably, the film or a dried or cured layer, preferably the dried or cured, preferably dried, layer applied at least in portion over the metallic surface of the metal-plastic hybrid material has a coating weight determined by XRF (X-ray fluorescence spectroscopy) of:
0.1 to 40 mg/m², more preferably 0.2 to 30 mg/m², even more preferably 0.5 to 20 mg/m², still more preferably 1.0 to 15 mg/m², yet more preferably 1.5 to 10 mg/m², in particular 2.0 to 8 mg/m², of zirconium and/or titanium and/or hafnium, preferably of zirconium and/or titanium, more preferably of zirconium, in each case calculated as metal, due to the presence of constituent a2) in the acidic aqueous composition used,
0 or 0.1 to 40 mg/m², more preferably 0 or 0.2 to 30 mg/m², even more preferably 0 or 0.5 to 20 mg/m², still more preferably 0 or 1.0 to 15 mg/m², yet more preferably 0 or 1.5 to 10 mg/m², in particular 2.0 to 8 mg/m², of molybdenum, calculated as metal.

If the at least one thermoplastic polymeric material TM2 is present within the metal-plastic hybrid material, then preferably optional step 3a) of the inventive method has been performed. In this case, the thermoplastic polymeric material TM1 has been applied in form of a foil in step 2) and in step 3a) the thermoplastic polymeric material TM2 has been applied on top via injection molding.

If the further substrate S2 having also at least one metallic surface made at least partially of aluminum and/or at least one kind of aluminum alloy is present within the metal-plastic hybrid material, then preferably optional step 3b) of the inventive method has been performed. In this case, the thermoplastic polymeric material TM1 has been applied in form of a foil in step 2) and in step 3b) the substrate S2, after its at least one metallic surface has been treated with an acidic aqueous composition as well in accordance with step 1), has been applied with its treated surface in adjacent position to the foil formed from thermoplastic polymeric material TM1, resulting in the overall formation of a sandwich structure, wherein the foil made by using TM1 is flanked by the two metallic surfaces of the two substrates S1 and S2, each of the two metallic surfaces bearing a coating layer obtained by treatment step 1). Preferably, when the metal-plastic hybrid material comprises a further substrate S2, it can be regarded as a sandwich structure comprising two substrates S1 and S2, wherein each of these substrates is adhered to one surface of the thermoplastic material TM1, which is present in form of a foil, by means of an adherent film or dried or cured layer being obtainable from application the aqueous acidic composition as defined in connection with aforementioned step 1) of the inventive method. Preferably, substrates S1 and S2 each are sheets or coils made of aluminum and/or an alloy thereof. Each coil or sheet may have a total thickness in a range of from 0.2 mm to 3 mm, depending on the desired application.

### Use of the Metal-Plastic Hybrid Material

A further subject-matter of the present invention is a use of said metal-plastic hybrid material or of the metal-plastic hybrid material obtainable by the inventive method as component in the automotive, construction or electronic industry.

All preferred embodiments described above herein in connection with the inventive method, the inventive metal-plastic hybrid material obtainable by said method, the aforementioned inventive use, the inventive metal-plastic hybrid material as such, and preferred embodiments thereof, are also preferred embodiments of the inventive use of the metal-plastic hybrid material.

In particular, a metal-plastic hybrid material, wherein the substrate S1 and the optionally present substrate S2 are foils, can be used for E-mobility applications, the manufacture of parts for the electronic industry, and/or for the manufacture of automotive parts, in particular, where weight reduction is needed. Further possible uses include, Lidar and EMI shielding applications, manufacture of panel controls in cars, manufacture of battery housings and of protections panels for batteries.

### Methods

### 1. Crosscut Testing to DIN EN ISO 2409 (06-2013)

The crosscut test is used to ascertain the strength of adhesion in accordance with DIN EN ISO 2409 (06-2013). Cutter spacing is 3 mm. Assessment takes place on the basis of characteristic cross-cut values in the range from 0 (very good adhesion) to 5 (very poor adhesion). The test is performed three times for each sample and an average value is determined.

2. Determination of Average Molecular Weights M_{w} and Mₙ

The number average and weight average molecular weights (Mₙ and M_{w}), respectively, are measured according to the following protocol: Samples are analyzed by SEC (size exclusion chromatography) equipped with a MALS detector. Absolute molar masses are obtained with a dn/dC value chosen equal to 0.1875 mL/g in order to get a recovery mass around 90%. Polymer samples are dissolved in the mobile phase and the resulting solutions are filtrated with a Millipore filter 0.45 μm. Eluting conditions are the following ones. Mobile phase: H₂O 100% vol. 0.1 M NaCl, 25 mM NaH₂PO₄, 25 mM Na₂HPO₄; 100 ppm NaN₃; flow rate: 1 mL/min; columns: Varian Aquagel OH mixed H, 8 μm, 3*30 cm; detection: RI (concentration detector Agilent)+MALLS (Multi Angle Laser Light Scattering) Mini Dawn Tristar+UV at 290 nm; samples concentration: around 0.5 wt % in the mobile phase; injection loop: 100 μL. Polydispersity P can be calculated from the Mₙ and M_{w} values obtained.

### 3. Free Fluoride Content Determination

The free fluoride content is determined by means of a fluoride ion selective electrode. The electrode is calibrated using at least three master solutions with known fluoride concentrations. The calibration process results in the building of calibration curve. Then the fluoride content is determined by using of the curve.

### 4. ICP-OES

The amounts of certain elements in a sample under analysis, such as of zirconium, titanium, hafnium etc., is determined using inductively coupled plasma atomic emission spectrometry (ICP-OES) according to DIN EN ISO 11885 (date: Sep. 1, 2009). A sample is subjected to thermal excitation in an argon plasma generated by a high-frequency field, and the light emitted due to electron transitions becomes visible as a spectral line of the corresponding wavelength and is analyzed using an optical system. There is a linear relation between the intensity of the light emitted and the concentration of the element in question. Prior to implementation, using known element standards (reference standards), the calibration measurements are carried out as a function of the particular sample under analysis. These calibrations can be used to determine concentrations of unknown solutions such as the concentration of the amount of titanium, zirconium and hafnium.

### 5. Tensile Strength

Tensile strength was measured according to ISO 527-1:2012.

### Examples

The following examples further illustrate the invention but are not to be construed as limiting its scope.

### 1. Preparation of Acidic Aqueous Coatinq Compositions

1.1 A number of acidic aqueous compositions A1 to A3 have been prepared (1 L each). All aqueous compositions contained H₂ZrF₆ in an amount that corresponds to the ppm values of zirconium, calculated as metal, as illustrated in Table 1a below. All aqueous compositions further contained ammonium heptamolybdate in an amount that corresponds to the ppm values of molybdenum, calculated as metal, as illustrated in Table 1 below. All compositions were chromium-free and contained free fluoride anions. Each of the compositions further contained one of the following water-soluble polymers P1 to P3:
P1: Commercially available polyacrylic acid having a M_{w} of >150,000 g/mol,
P2: Copolymer of maleic acid and vinyl methyl ether,
P3: Copolymer of maleic acid and ethylene.

TABLE 1a

| | pH | Amount of | Amount of | Amount of |
|---|---|---|---|---|
| Composition | value | polymer [g/L] | Zr [g/L] | Mo [g/L] |
| A1 | 3.6 | P1: 0.25 | 0.5 | 0.05 |
| A2 | 3.6 | P2: 0.50 | 0.5 | 0.05 |
| A3 | 3.6 | P3: 0.18 | 0.5 | 0.05 |

1.2 A number of further acidic aqueous compositions A4 to A6 have been prepared (1 L each). All aqueous compositions contained H₂ZrF₆ in an amount that corresponds to the ppm values of zirconium, calculated as metal, as illustrated in Table 1 b below. All aqueous compositions further contained ammonium heptamolybdate in an amount that corresponds to the ppm values of molybdenum, calculated as metal, as illustrated in Table 1b below. All compositions were chromium-free and contained free fluoride anions. Each of the compositions further contained one of the water-soluble polymers P1 to P3 as already identified hereinbefore.

TABLE 1b

| | | | | | Amount |
|---|---|---|---|---|---|
| | | Amount | Amount | Amount | of free |
| | pH | of polymer | of Zr | of Mo | fluoride |
| Composition | value | [g/L] | [g/L] | [g/L] | [mg/L] |
| A4 | 3.8 | P1: 1.0 | 0.5 | 0.05 | 12 |
| A5 | 3.8 | P2: 1.0 | 0.5 | 0.05 | 13 |
| A6 | 3.8 | P3: 1.0 | 0.5 | 0.05 | 12 |

### 2. Pretreatment

2.1 As substrate an aluminum alloy substrate (substrate T1; 5754 AIMg3) has been used in form of a coil. 5754 AIMg3 is an aluminum magnesium alloy substrate.

The substrate was cleaned by making use of the commercial alkaline product Gardoclean® S 5160 (at 60 to 70° C.). Then, rinsing with tap water was performed twice (for 30 seconds each). Next, an acid pickling step was performed by making use of the commercial product Gardoclean® S 5240/2. Then, a rinsing with tap water (30 seconds) followed by rinsing with deionized water (30 seconds) was performed.

Then a contacting step was carried out, i.e., the surface of the substrate was contacted with one of the acidic aqueous compositions A1 to A3 described hereinbefore in item 1.1 in order to form a conversion coating layer on the surface of the substrate with adhesion promoting properties. The contacting step was performed in each case for 60 seconds by spraying of one of the acidic aqueous compositions onto the surfaces of the substrates. The acidic aqueous compositions were heated to 25° C. before spraying.

Following the contacting step, a drying step is performed (15 minutes at 60 to 70° C.) after a period of air blowing. The resulting dry layer thickness was in a range of from 50 to 200 nm.

2.2 As substrate an aluminum alloy substrate (substrate T2; AA 6060) has been used.

The substrate was cleaned by making use of the commercial alkaline product Gardoclean® T 5281 A (at 55° C.). Then, rinsing with tap water was performed twice (for 30 seconds each). Next, an acid pickling step was performed by making use of the commercial product Gardacid® P 4432. Then, a rinsing with tap water was performed thrice (for 60 seconds each).

Then a contacting step was carried out, i.e., the surface of the substrate was contacted with one of the acidic aqueous compositions A4 to A6 described hereinbefore in item 1.2 in order to form a conversion coating layer on the surface of the substrate with adhesion promoting properties. The contacting step was performed in each case for 60 seconds by spraying of one of the acidic aqueous compositions onto the surfaces of the substrates. The acidic aqueous compositions were heated to 30° C. before spraying.

Following the contacting step, a rinsing with tap water was performed thrice (for 60 seconds each).

Then, a drying step is performed (8 minutes at 100° C.) after a period of air blowing.

### 3. Preparation of Metal-Plastic Hybrid Materials

3.1 A mixture of polybutylene terephthalate (PBT) as thermoplastic polymeric material and glass fibres (commercially available product Tecadur® PBT-GF30) was applied by injection molding at a temperature between 18° and 240° C. directly onto the surfaces of the substrates obtained after the pretreatment as described in item 2.1. The resulting laminates produced by injection molding had a thickness (of the plastic layer) in a range of from 400 μm to 2 cm, depending on the desired application.

3.2 Sandwich structures were also generated in the same manner as described in item 3.1., wherein, however, Tecadur® PBT-GF30 was injected between two surfaces of two substrates, each obtained after the pretreatment as described in item 2.1.

3.3 A mixture of polybutylene terephthalate (PBT) as thermoplastic polymeric material and glass fibres (commercially available product Tecadur® PBT-GF30) was applied by injection molding at a temperature between 18° and 240° C. directly onto the surfaces of the substrates obtained after the pretreatment as described in item 2.2. The resulting laminates produced by injection molding had a thickness (of the plastic layer) in a range of from 400 μm to 2 cm, depending on the desired application.

### 4. Properties of the Obtained Metal-Plastic Hybrid Materials

4.1 A number of properties of the products obtained by the method described hereinbefore in items 3.1 and 3.2 have been investigated. These properties were determined according to the test methods described hereinbefore. The results are displayed in Tables 2 and 3. In particular, the adhesion strength was investigated.

TABLE 2

| Aqueous composition used for | |
|---|---|
| chemical pretreatment | Crosscut |
| A1 | 0 |
| A2 | 0 |
| A3 | 0 |

As it is evident from Table 2, an excellent adhesion of PBT to the metallic substrates was achieved in all cases.

TABLE 3

| Aqueous composition used for | Tensile strength |
|---|---|
| chemical pretreatment | [MPa] |
| A1 | 23.7 |
| A2 | 20.8 |
| A3 | 15.0 |

For the sandwich structure a peel off test was performed. The results showed that no peel off could be obtained.

4.2 A number of properties of the products obtained by the method described hereinbefore in item 3.3 have been investigated. These properties were determined according to the test methods described hereinbefore. The results are displayed in Table 4 In particular, the adhesion strength was investigated.

TABLE 4

| Aqueous composition used for | |
|---|---|
| chemical pretreatment | Crosscut |
| A4 | 0 |
| A5 | 0 |
| A6 | 0 |

As it is evident from Table 4, an excellent adhesion of PBT to the metallic substrates was achieved in all cases.

1. A method for preparing a metal-plastic hybrid material, said material comprising a substrate S1 having at least one metallic surface and at least one thermoplastic material applied onto said metallic surface of the substrate S1, the method comprising at least steps 1) and 2) and optionally step 3a) or 3b);
1) applying an aqueous acidic composition at least in portion onto the at least one metallic surface of the substrate S1 to form a film at least in portion on said surface,
wherein the metallic surface is made at least partially of aluminum and/or of at least one kind of aluminum alloy, and
wherein the acidic aqueous composition comprises, besides water, at least one water-soluble polymer having least one kind of functional groups selected from the group consisting of acid groups, hydroxyl groups, amino groups, and mixtures thereof as at least one constituent a1), at least one metal cation selected from the group consisting of titanium, zirconium and hafnium ions, and mixtures thereof, as at least one constituent a2), and free fluoride anions as at least one constituent a3), and
and optionally drying or curing the film to form a dried or cured layer,
2) applying at least one thermoplastic polymeric material TM1 at least in portion onto the film or onto the dried or cured layer obtained after step 1),
wherein the at least one thermoplastic polymeric material TM1 is applied i) in a form of a foil or is applied ii) by injection in a molten state onto the film or onto the dried or cured layer obtained after step 1) to form the metal-plastic hybrid material, and
3a) optionally injecting at least one thermoplastic polymeric material TM2, which is identical to or different from the thermoplastic material TM1 applied in step 2), and which is present in molten state, at least in portion onto the surface of the foil of the metal-plastic hybrid material obtained after step 2) and i), or
3b) optionally applying a further substrate S2 having at least one metallic surface, said surface being made at least partially of aluminum and/or at least one kind of aluminum alloy and having undergone the treatment of method step 1), onto the surface of the foil of the metal-plastic hybrid material obtained after step 2) and i) or vice versa.

2. The method according to claim 1, wherein the acidic aqueous composition used in step 1) has a pH value in a range of from 0.1 to <7.0.

3. The method according to claim 1, wherein the at least one water-soluble polymer used as constituent a1) is present in the acidic aqueous composition in an amount in a range of from 0.05 to 2.0 g/L.

4. The method according to claim 1, wherein the at least one water-soluble polymer used as constituent a1) has at least one kind of functional group selected from the group consisting of carboxylic acid groups, phosphonic acid groups, sulfonic acid groups, hydroxyl groups, amino groups, and mixtures thereof.

5. The method according to claim 1, wherein the at least one water-soluble polymer used as constituent a1) is a homopolymer or copolymer obtainable from polymerization of at least one kind of ethylenically unsaturated monomers, wherein at least part of said monomers bear at least one kind of functional group selected from the group consisting of acid groups, hydroxyl groups, amino groups, and mixtures thereof.

6. The method according to claim 1, wherein the at least one water-soluble polymer used as constituent a1) is selected from the group consisting of (meth)acrylic acid homopolymers, acrylic acid homopolymers, copolymers of (meth)acrylic acid and at least one kind of ethylenically unsaturated monomers different from (meth)acrylic acid, copolymers of (meth)acrylic acid and maleic acid, copolymers of maleic acid and at least one kind of ethylenically unsaturated monomers different from maleic acid, copolymers of maleic acid and ethylene and/or propylene and/or at least one kind of alkyl vinyl ethers such as methyl vinyl ether, copolymers of vinyl phosphonic acid and at least one kind of ethylenically unsaturated monomers different from vinyl phosphonic acid, copolymers of (meth)acrylic acid and vinyl phosphonic acid, copolymers of (meth)acrylic acid and vinyl phosphonic acid and maleic acid, vinyl alcohol homopolymers, copolymers of vinyl alcohol and at least one kind of ethylenically unsaturated monomers different from vinyl alcohol, vinyl phenol homopolymers, copolymers of vinyl phenol and at least one kind of ethylenically unsaturated monomers different from vinyl phenol, copolymers of vinyl mercaptoethanol and at least one kind of ethylenically unsaturated monomers different from vinyl mercaptoethanol, homopolymers and copolymers of vinyl phenol that have been modified with at least one amine, homopolymers and copolymers of vinyl phenol that have been modified with at least one primary amine, homopolymers and copolymers of vinyl phenol that have been modified with N-ethanolamine and/or N-methyl glucamine, and mixtures thereof.

7. The method according to claim 1, wherein the at least one water-soluble polymer used as constituent a1) is selected from the group consisting of (meth)acrylic acid homopolymers, acrylic acid homopolymers, copolymers of (meth)acrylic acid and at least one kind of ethylenically unsaturated monomers different from (meth)acrylic acid, copolymers of (meth)acrylic acid and maleic acid, copolymers of maleic acid and at least one kind of ethylenically unsaturated monomers different from maleic acid, copolymers of maleic acid and ethylene and/or propylene and/or at least one kind of alkyl vinyl ethers such as methyl vinyl ether, vinyl alcohol homopolymers, copolymers of vinyl alcohol and at least one kind of ethylenically unsaturated monomers different from vinyl alcohol, homopolymers and copolymers of vinyl phenol, that have been modified with at least one amine, homopolymers and copolymers of vinyl phenol that have been modified with at least one primary amine, homopolymers and copolymers of vinyl phenol that have been modified with N-ethanolamine and/or N-methyl glucamine.

8. The method according to claim 1, wherein the aqueous acidic composition used in step 1) comprises the at least one constituent a2) in an amount in a range of from 0.1 to 10.0 g/L, in each case calculated as metal.

9. The method according to claim 1, wherein the aqueous acidic composition used in step 1) further comprises molybdenum cations as at least one constituent a4).

10. The method according to claim 1, wherein the at least one thermoplastic polymeric material TM1 and the at least one thermoplastic polymeric material TM2 are independently selected from the group consisting of polyamides, polyesters, polyethylene terephthalate (PET), polybutylene terephthalate (PBT), polyurethanes, polycarbonates, polyolefins, polypropylenes, polyethylenes, and mixtures thereof.

11. A metal-plastic hybrid material obtained by the method according claim 1.

12. A method of using the acidic aqueous composition as defined in claim 1, the method comprising using the acidic aqueous composition for adhering a metallic surface made at least partially of aluminum and/or of at least one kind of aluminum alloy of a substrate to a thermoplastic polymeric material present on said surface in form of a foil or applied onto said surface by injection molding.

13. The metal-plastic hybrid material according to claim 11, wherein the at least one thermoplastic polymeric material TM1 is applied i) in a form of a foil, the metal-plastic hybrid material further comprising at least one of
at least one thermoplastic polymeric material TM2, which is identical to or different from the thermoplastic polymeric material TM1, applied at least in portion in a form obtained from an injection molding over the at least one thermoplastic polymeric material TM1,
and
a substrate S2 having at least one metallic surface, said surface being made at least partially of aluminum and/or at least one kind of aluminum alloy, said substrate bearing a film or dried or cured layer applied at least in portion over said metallic surface, the film or dried or cured layer being obtained from applying the aqueous acidic composition, wherein said film or dried or cured layer present at least in portion on said metallic surface of the substrate S2 is in an adjacent position to the at least one thermoplastic polymeric material TM1.

14. The metal-plastic hybrid material according to claim 11, wherein at least the film or dried or cured layer, being obtained from applying the aqueous acidic composition to the metallic surface of substrate S1, has a dry layer thickness in a range of from 100 to 1000 nm and/or in that the film or dried or cured layer.

15. A method of using the metal-plastic hybrid material according claim 11, the method comprising using the metal-plastic hybrid material as a component in the automotive, construction or electronic industry.

16. The method according to claim 1, wherein the acidic aqueous composition used in step 1) has a pH value in a range of from 0.5 to <6.5.

17. The method according to claim 1, wherein the at least one water-soluble polymer used as constituent a1) is present in the acidic aqueous composition in an amount in a range of from 0.10 to 1.8 g/L.

18. The method according to claim 1, wherein the at least one water-soluble polymer used as constituent a1) has at least one kind of functional group selected from the group consisting of carboxylic acid groups, hydroxyl groups, amino groups, and mixtures thereof.

19. The method according to claim 1, wherein the at least one water-soluble polymer used as constituent a1) is a homopolymer or copolymer obtainable from polymerization of at least one kind of ethylenically unsaturated monomers, wherein at least part of said monomers bear at least one kind of functional group selected from the group consisting of homopolymers or copolymers obtained from polymerization of at least one kind of vinyl monomers and/or (meth)acrylic monomers.

20. The method according to claim 1, wherein the at least one water-soluble polymer used as constituent a1) is selected from the group consisting of N-Methyl glucamine-modified poly(vinyl phenol), N-ethanolamine-modified poly(vinyl phenol), poly(maleic acid-co-vinyl methyl ether), poly(maleic acid-co-acrylic acid), polyacrylic acid, poly(vinyl-phosphonic acid-co-acrylic acid), poly(acrylic acid-co-maleic acid-co-vinyl phosphonic acid), poly(acrylic acid-co-maleic acid-co-vinyl mercaptoethanol), and mixtures thereof.
